(19) United States
(12) Patent Application Publication
(10) Pub. No.: US 2011/0035364 A1
(43) Pub. Date: Feb. 10, 2011

(54) SYSTEM AND METHOD OF COORDINATING CONSISTENCY OF KEY TERMS THROUGHOUT A PLURALITY OF DOCUMENTS

(75) Inventor: James B. Lipsey, Denver, CO (US)

Correspondence Address: Law Office of Daniel W. Roberts, 904 Topaz Street, Superior, CO, 80027, US

(73) Assignee: Demonstrare, Corp., Broomfield, CO (US)

(21) Appl. No.: 12/845,208

(22) Filed: Jul. 28, 2010

Related U.S. Application Data
(60) Provisional application No. 61/232,087, filed on Aug. 7, 2009.

(51) Int. Cl. G06F 17/30; G06F 17/00

(52) U.S. Cl. 707/690; 707/744; 707/E17.084; 707/E17.007

(57) ABSTRACT

Provided is a method and system for coordinating consistency of key terms throughout a plurality of documents. The method includes identifying at least one key term in a first document provided by a first third-party application. The key term has at least a text element and a numerical element. Each additional instance of the key term in the first document is then linked. Each instance of the key term in at least one second document provided by a second third-party application is then also linked. An index is established for each identified key term and all instances of each key term in each document, the index permitting navigation to any specific instance of the key term in the first or second document. Each instance of each key term has selectable visibility for both the text element and the numerical element such that in varying instances, both the text element and the numerical element are visible, the text element is visible and the numerical element is invisible, and the text element is invisible and the numerical element is visible. An associated system is also provided.

### CROSS REFERENCE TO RELATED APPLICATIONS

This application claims the benefit under 35 U.S.C. §119(e) of U.S. Provisional Application No. 61/232,087, filed Aug. 7, 2009, entitled “System And Method For Authoring, Editing, Examining And Researching For Areas Where Written Descriptions And Graphical Information Need To Be Displayed And Interact Between Them” the disclosure of which is incorporated herein by reference.

### FIELD OF THE INVENTION

The present invention relates generally to coordinating the consistency of key terms throughout a plurality of documents. More specifically, the invention relates to a system and method for assisting in the drafting of patent applications.

### BACKGROUND

In today's interactive world it is not uncommon for an author or multiple authors to work with a number of different but interrelated documents which collectively are intended to convey the thoughts, ideas, teachings or other values to the readers of the collective documents. For example, a teacher or professor may provide a series of presentation slides and a summary of lecture notes. Sales and management personnel often prepare charts and graphs along with detailed written reports and/or high-level summaries. And of course those skilled in the art of patent prosecution prepare detailed written descriptions with accompanying claim sets and illustrative drawings as patent applications.

The consistency of key terms throughout the collective documents is a most important factor in properly conveying the intended meaning of the author to the reader. When and where key terms are not consistent, confusion may result. In other cases a completely erroneous opinion or understanding may be formed on the part of the reader.

Such errors in consistency may result from typographical issues, or even faulty memory on the part of the author. Where multiple parties are involved in the authoring process, the opportunity for inadvertent error is even greater.

Shakespeare's Richard III famous quote, “A horse! A horse! My kingdom for a horse!” evokes quite a different feeling if misstated “A house! A house! My kingdom for a house!” Expanding this simple error to a case involving multiple related documents, the reference to a “horse” in one document but a “house” in another, and perhaps a “hearse” in a third quickly leads to a state of utter confusion.

The issues of consistency can be even more cumbersome when dealing with related documents of different types. This is quite common in the art of patent application preparation where a word processing application is utilized to provide a textual document as the written description and a graphical application is utilized to provide illustrated figures. Intended to enhance the understanding of the written description.

In many instances the drawings or figures may be prepared by a person other than he or she who is authoring the written description, thus again introducing an opportunity of a lack of consistency in key terms. Indeed, with respect to a patent application a key term may be an element of critical importance in the description, a significant claim element and represented in varying views in a plurality of figures, if not also a direct reference to a specific figure.

Typically the author of a patent application, or part thereof, is not the inventor named in the application. Rather a patent attorney, patent agent, technical writer and perhaps draftsman work collaboratively with frequent drafts being exchanged with the inventor or inventors to insure that the evolving description captures the essence of the invention. It is not uncommon for portions of the description to be moved from one location to another, expanded or redacted—actions that can and do affect the order and presentation of the accompanying drawings as well as the presentation and usage of other key terms in both the written description and the drawings.

An error in consistency between instances of a key term can have devastating consequences for the application. Proofing is therefore a common and manual activity employed in a valiant, but occasionally vain effort to insure key term consistency.

A number of different tools have been proposed to assist with patent application preparation and efficiency but they tend to suffer from significant limitations. A key term can properly exist in a variety of different forms such as appearing in the possessive, plural and capitalized forms. Further key terms are often comprised of multiple elements, such as text and numbers, and in varying instances complete or partial usage of the elements is appropriate. A failing to recognize the possibility of a different form significantly undermines the goal of achieving proper consistency.

Further still, human beings are creatures of habit and preference. Different people prefer to use different word processing applications and different drawing applications. Requiring an author to forego his or her preferred authoring environment may well introduce diminished quality in the authored work due simply to lack of comfort and/or confidence in being required to use an unfamiliar system.

Yet another group of individuals have also been overlooked—the Patent Examiners. As the Patent Office strives for efficiency and improved quality of examination not only are issues of key term consistency of importance to the applicant and the authors of the detailed description and drawings, but key term consistency is highly beneficial to the Patent Examiners as well. Faced with a lengthy description, an articulate claim set and a highly informative set of supporting figures and illustrations, the Examiner is for the most part unable to immediately identify a key term and all instances and locations thereof in both the textual and illustrative portions of the application.

Hence there is a need for a system and method of coordinating consistency of key terms throughout a plurality of documents.

### SUMMARY

This invention provides a system and method of coordinating consistency of key terms throughout a plurality of documents.

In particular, and by way of example only, according to one embodiment of the present invention, provided is a method of coordinating consistency of key terms throughout a plurality of documents, the method including: identifying at least one key term in a first document provided by a first third-party application, the key term having at least a text element and a numerical element; linking each additional instance of the key term in the first document; linking each instance of the key term in at least one second document provided by a second third-party application; establishing for each identified key term a link index for all instances of each key term in each document, the index permitting navigation to any specific instance of the key term in the first or second document; and permitting for each instance of each key term the visibility of the elements to be selectable from the group consisting of: both the text element and the numerical element are visible, the text element is visible and the numerical element is invisible, and the text element is invisible and the numerical element is visible.

In another embodiment, provided is a system of coordinating consistency of key terms throughout a plurality of documents, including: a coordinator structured and arranged to coordinate information between at least one first word processing document and at least one second illustration document; an identifier, structured and arranged to permit identification of at least one key term in either document, the key term having at least a text element and a numerical element; an index structured and arranged to link and index each instance of each identified key term in each document; a controller structured and arranged to control a user's interactions with either document, the controller responding to a user event by; in a first instance; presenting at least a portion of the index to a user in response to a user event; and receiving a user selection from the index and moving to the linked selected instance in either the first or second document; and in a second instance; noting a user modification to either the text element or the numerical element of a key term; and querying the user to confirm the modification to at least a subset of the linked instances of the key term.

In yet another embodiment, provided is a method of coordinating consistency of key terms throughout a plurality of documents, the method including: providing an environment for interrelating data as between at least one word processing document and at least one illustration document; identifying at least one key term in either the word processing document or the illustration document as a first document, the key term having at least a text element and a numerical element; linking each additional instance of the key term in the first document; linking each instance of the key term in at least one second document; and establishing for each identified key term a link index for all instances of each key term in each document, the index permitting navigation to any specific instance of the key term in the first or second document.

Further still, in yet another embodiment, provided is a method of coordinating consistency of key terms throughout a plurality of documents, the method including: providing an environment for interrelating data as between at least one word processing document provided by a third-party word processor and at least one illustration document provided by a third-party drawing application; identifying at least one key term in either the word processing document or the illustration document as a first document, the key term having at least a text element and a numerical element; linking each additional instance of the key term in the first document; linking each instance of the key term in at least one second document; permitting for each instance of each key term the visibility of the elements to be selectable from the group consisting of; both the text element and the numerical element are visible, the text element is visible and the numerical element is invisible, and the text element is invisible and the numerical element is visible; establishing for each identified key term a link index for all instances of each key term in each document, the index permitting navigation to any specific instance of the key term in the first or second document; and responding to a user event by; in a first instance; presenting at least a portion of the index to a user in response to a user event; and receiving a user selection from the index and moving to the linked selected instance in either the first or second document; and in a second instance; noting a user modification to either the text element or the numerical element of a key term; and querying the user to confirm the modification to at least a subset of the linked instances of the key term.

### BRIEF DESCRIPTION OF THE DRAWINGS

At least one system and method of coordinating consistency of key terms throughout a plurality of documents will be described, by way of example in the detailed description below with particular reference to the accompanying drawings in which like numerals refer to like elements, and:

FIG. 1 illustrates a high level block diagram of a system for coordinating consistency of key terms throughout a plurality of documents in accordance with at least one embodiment;

FIG. 2 is a high level flow diagram for a method of coordinating consistency of key terms throughout a plurality of documents in accordance with at least one embodiment;

FIG. 3 illustrates the presentation of a word processing document and an illustration document within an environment for the coordinating consistency of key terms throughout a plurality of documents, further illustrating the identification of a key term in accordance with at least one embodiment;

FIG. 4 illustrates a portion of an index table for indexing and linking all instances of each key term in each document in accordance with at least one embodiment;

FIG. 5 illustrates the presentation of a word processing document and an illustration document as shown in FIG. 3 further illustrating a floating bubble for controlling consistency of a selected key term in accordance with at least one embodiment;

FIG. 6 illustrates the advantageous ability to revise and insert key terms and shift number elements in accordance with at least one embodiment; and

FIG. 7 is a block diagram of a computer system in accordance with at least one embodiment.

### DETAILED DESCRIPTION

Before proceeding with the detailed description, it is to be appreciated that the present teaching is by way of example only, not by limitation. The concepts herein are not limited to use or application with a specific of system or method of coordinating consistency of key terms throughout a plurality of documents. Thus although the instrumentalities described herein are for the convenience of explanation shown and described with respect to exemplary embodiments, it will be understood and appreciated that the principles herein may be applied equally in other types of systems and methods involving coordinating consistency of key terms throughout a plurality of documents.

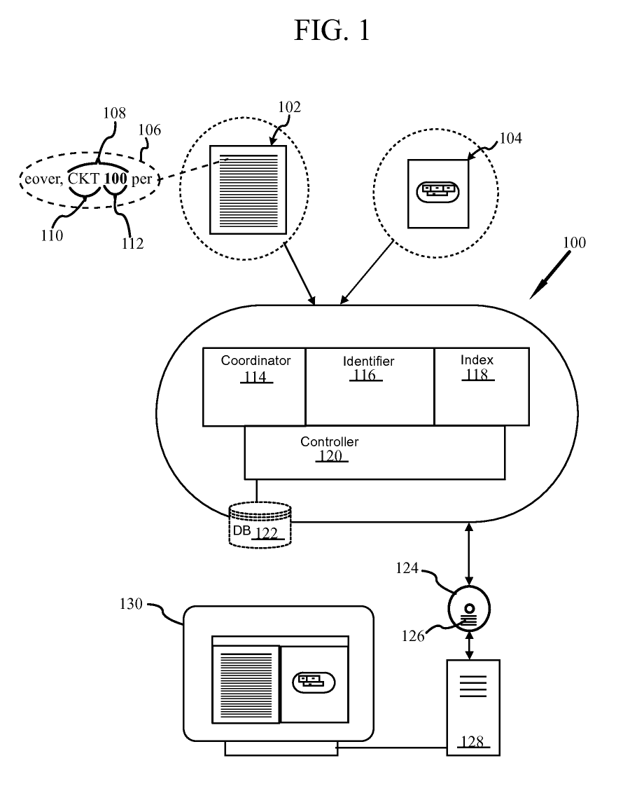

Turning now to the drawings, and more specifically FIG. 1, illustrated is a high level block diagram of a system for coordinating consistency of key terms throughout a plurality of documents (“CKT”) 100. As is further described in detail below, stated generally for at least one embodiment CKT 100 is structured and arranged to provide an environment for interrelating data as between a plurality of documents, of which a first document 102 and a second document 104 are exemplary.

Further in at least one embodiment the first document 102 is a text document, e.g., a word processing document, and the second document 104 is an illustration document. It is further understood of course that in varying embodiments the first document 102 is an illustration document and the second document 104 is a text document, e.g., a word processing document. It is further understood and appreciated that the tangible value of word and illustration documents is beyond reproach. As human beings, reliance on the written word and illustration for the conveyance of information from one person to the next and from one generation to the next is of the utmost importance. The accuracy of the information provided by the text and illustration can be of extreme importance and as suggested above, errors in the consistency of terms, especially key terms can have profound consequences.

In varying embodiments the first document 102 and the second document 104 are each provided by third party applications. For example, in varying embodiments the first document 102 may be provided by a word processor application selected from, but not limited to, Microsoft Word®, WordPerfect®, or Pages®. Similarly, in varying embodiments the second document 104 may be provided by an illustrating application selected from, but not limited to, Microsoft Visio®, Microsoft Paint®, Adobe Photoshop®, Adobe Illustrator®, CorelDraw®, AutoCAD®, CoCreate® and Solid Works®. Moreover, it is understood and appreciated that the first document 102 can be provided a word processing application of varying scope and complexity ranging from the very simple to the very sophisticated. Likewise the second document 104 can be provided by a graphics viewer/illustrating application that can be complex or simple.

Moreover, CKT 100 permits the coordination of key terms between a plurality of different documents provided by a range of different applications that are advantageously familiar to users. In other words, CKT 100 does not require the use of a specific, and potentially foreign word processing application and/or illustration application for the selection of one or more elements.

With respect to FIG. 1 and more specifically first document 102, an enlarged portion is shown in dotted relief 106 so as to illustrate a key term 108, e.g., “CKT 100.” Key term 108 has a text element 110 and a numerical element 112.

In the illustrated exemplary embodiment, CKT 100 is shown to include a coordinator 114, an identifier 116, an index 118 and a controller 120. The coordinator 114 is structured and arranged to coordinate information between at least one first document 102 and at least one second document 104. In at least one embodiment the coordinator 114 is so equipped with a one or more collections of macros, scripts, libraries, references to dynamic link libraries, ActiveX components or the like for enabling automation and integration of CKT 100 with a variety of third party applications for words processing and illustrating.

The identifier 116 is structured and arranged to permit identification of at least one key term 108 in either document. In at least one embodiment the identifier 116 incorporates appropriate command and control elements for a variety of text selection processes such as for example the double clicking a mouse cursor, the shift-arrow keyboard selection and/or other such options as are commonly utilized in word processing and illustrating applications.

The index 118 is structured and arranged to link and index each instance of each identified key term 108 in each document. In at least one embodiment the index 118 incorporates appropriate command and control elements for a variety of global text selection processes such as for example the “find” and/or “find all” commands as are commonly utilized in word processing and illustrating applications.

The controller 120 is structured and arranged to control a user's interactions with either document and the interaction of the coordinator 114, the identifier 116 and the index 118. The controller 120 may also be structured and arranged to control access to an optional database 122 which may be provided as part of CKT 100 or remotely accessible and/or provided by another system, not shown.

With respect to CKT 100, it is understood and appreciated that in varying embodiments the elements, e.g., the coordinator 114, the identifier 116 and the index 118 and controller 120 may be provided as software routines, hardware elements and/or combinations thereof.

The elements of CKT 100, e.g., the coordinator 114, the identifier 116 and the index 118 and controller 120 have been illustrated distinctly for ease of illustration and discussion. In varying embodiments of course it is understood and appreciated that one or more of these elements may be combined and/or further subdivided into a number of sub-elements.

With respect to FIG. 1, CKT 100 is conceptually illustrated in the context of an embodiment for a computer program. Such a computer program can be provided upon a non-transitory computer readable media, such as an optical disc 124, having encoded thereto an embodiment of CKT 100 as computer executable instructions 126, is provided to a computer 128. CKT 100 may be employed on a computer 128 having typical components such as a processor, memory, storage devices and input and output devices. During operation, the CKT 100 may be maintained in active memory for enhanced speed and efficiency. In addition, CKT 100 may also be operated within a computer network and may utilize distributed resources.

Moreover, CKT 100 is operable in a computer environment suitable for the operation of at least one word processing application and at least one illustration application, such as, but not exclusively limited to those identified above. However, it is understood and appreciated that upon execution of the instructions to implement CKT 100, the computer 128 is caused to function as an enhanced and specialized system for coordinating consistency of key terms throughout a plurality of documents.

Indeed, display 130 presents the user with a graphical interface facilitating the user's interaction with CKT 100 for the coordination of terms between the exemplary first and second documents 102 and 104

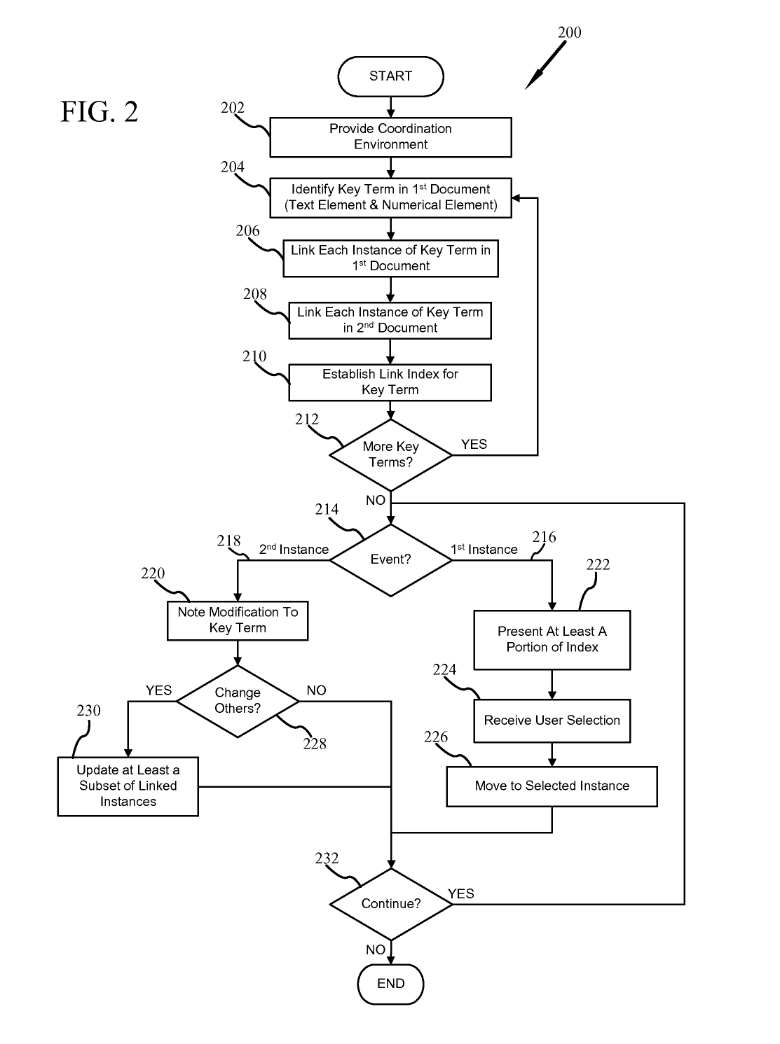

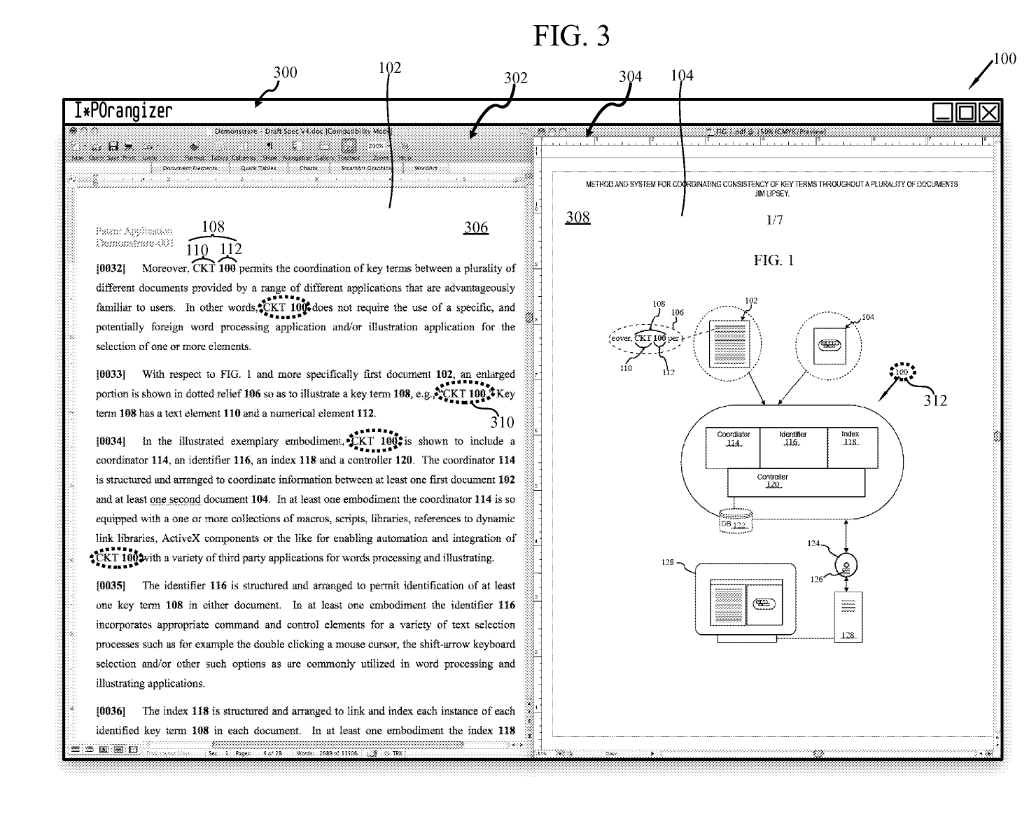

FIG. 2 in connection with FIGS. 3-6 provides a high level flow diagram with conceptual illustrations depicting at least one method 200 for coordinating consistency of key terms throughout a plurality of documents. It will be appreciated that the described method need not be performed in the order in which it is herein described, but that this description is merely exemplary of one method of coordinating consistency of key terms throughout a plurality of documents.

To summarize, in at least one embodiment, the method 200 includes identifying at least one key term in a first document provided by a first third-party application, the key term having at least one text element and a numerical element. Each additional instance of the key term is then linked in the first document. Each instance of the key term in at least one second document provided by a second third-party application is then also linked. An index is established for each identified key term, the index providing all links for all instances of each key term in the first or second document. Further, for each instance of the key term the visibility of the elements is selectable such that in varying instances, both the text element and the numerical element are visible, the text element is visible while the numerical element is invisible, and the text element is invisible while the numerical element is visible.

In at least one embodiment, the method 200 commences with the providing or establishing of a coordination environment, block 202. In varying embodiments, the method 200 for providing the environment may be achieved by providing CKT 100 as an application structured and arranged to permit a third party word processing application and a third party drawing application to be invoked directly from the CKT 100 application. Alternatively, the environment may be achieved by providing CKT 100 as a plug-in for either the third party word processing application or the drawing application.

In FIG. 3, the environment of CKT 100 is depicted as an application 300 identifier as I*POrganizer. As shown the application 300, I*POrganizer has both a third party word processor 302, e.g., Microsoft Word®, and a third party drawing application 304, e.g., Adobe Illustrator®, invoked. The word processor 302 is providing a word processing document 306 and the drawing application is providing an illustration document 308. In at least one embodiment, CKT 100 is structured and arranged to enhance navigation of the illustration document 308 by further providing thumbnail images (not shown) for each page of illustrations.

With the environment so established, a key term 108 is identified in a first document 102, block 204. It is substantially arbitrary as to whether the first document is the word processing document 306 or the illustration document 308 and in varying embodiments either may be treated as the first document. For the sake of convenience for illustration and discussion, in at least one embodiment the first document 102 is the word processing document 306.

As shown, the key term 108 initially identified is “CKT 100”, which includes a text element 110, e.g., “CKT,” and a numerical element 112, e.g., “100.” With key term 108 so identified, each instance of the key term in the first document 102 is then identified and linked, block 206. Moreover, four (4) additional instances of “CKT 100” that appear in the screen view of the word processing document 306 are shown in dotted relief 310 to indicate selection and linking. It is understood and appreciated that additional instance of the key term are also identified and linked, though not visible in the selected screen shot.

As most word processing applications include the ability to permit commands for “find” and/or “find all,” in at least one embodiment, CKT 100 utilizes one or more command libraries to engage the available find and replace capabilities of the third-party word processor to assist with finding additional instances of the key term throughout the document.

In varying embodiments, it is understood and appreciated that key terms may be presented in a variety of formats—including for example plural, possessive, capitalized, lowercase, and as acronyms. Incorporating automatic and/or user adjustable Boolean operators, the process of identifying additional instances of an indicated key term are easily permitted. In at least one embodiment, additional possible instances of a key term are presented to a user for his or her confirmation or rejection of the term as indeed a variant of the identified key term.

In at least one embodiment, each link as between the identified key term and additional instances thereof, is a hyperlink. More specifically, in at least one embodiment, the identified key term and each additional instance are encoded with metadata so as to function as hypertext, i.e., text with hyperlinks, which permit the user to navigate from one instance of the key term to another. From the user's perspective the hypertext is an on-screen input mechanism analogous to a button, switch or other physical input apparatus that a user might activate to invoke some action. In at least one embodiment the user of CKT 100 activates hypertext for a key term 108 by placing his or her cursor over the key term 108 and then “clicking” the mouse, track pad, digital pen or other device, such as by depressing a physical button.

A hyperlink is a coded reference to a document or location within a document that a user can follow to shift the focus from his or her present location, commonly known as the anchor, to the new location, commonly known as the target. As used in CKT 100, the hyperlinks are bidirectional such that both points act as anchors and targets, and in fact are many to many links. Although originally most commonly seen as links between documents accessible over the Internet, hyperlinks are well understood and can easily be employed within a more conventional document, e.g., first document 102 and the second document 104.

Moreover, hypertext and hyperlinks are terms of art. A modern and well known hypertext language is the HyperText Markup Language more commonly known simply as HTML. In at least one embodiment the hypertext behavior of a key term 108 is provided by XML (Extensible Markup Language) which is another set of rules for encoding documents in machine-readable form. Indeed the selection of which metadata or coding language is to be used for enabling the hypertext functionality of each key term 108 is likely dependent upon the environment used to instantiate an embodiment of CKT 100.

With each instance of the key term now linked in the first document, the method continues with linking each instance of the key term 108 in the second document, block 208. As shown in FIG. 3, the number element 100 in the illustration document 308 is shown in dotted relief 312 so as to indicate that it is an instance of the identified term, CKT 100. Further, it is appreciated that in this example only the numerical element is visible as the text element, e.g., “CKT” has been rendered invisible.

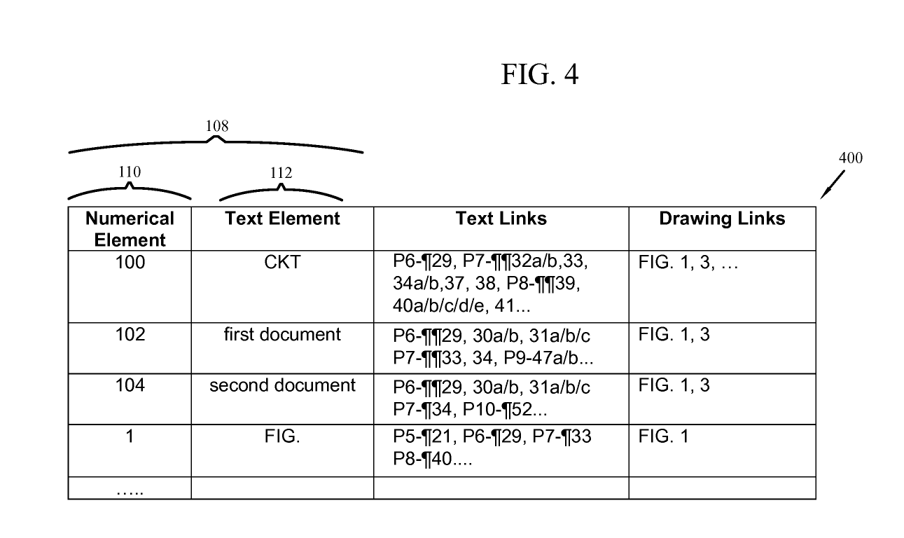

A link index is also established for each instance of each identified key term 108, block 210. In at least one embodiment, the link index 400, or simply just index 400, is represented as a table as shown in FIG. 4. It will be appreciated that the index 400 may be configured in a variety of different forms, and in at least one embodiment is user adjustable. In addition, in many instances the index 400 may not be readily apparent to a user, and/or may be an element that a user may choose to access directly for global modification, direct entry or deletion of terms, or other purposes.

In at least one embodiment, the index 400 is displayed as part of the environment of the application 300, such that a user may advantageously perceive and utilize a master list of all key terms as he or she adds or edits material in any document. For the exemplary embodiment shown, the link index 400 lists each instance of the key term 108 and presents the paragraph and/or page number for the key term 108 with respect to the first document, e.g., the word processing document. The link index 400 also lists each instance of the key term 108 in the second document, e.g., the illustration document 308. Multiple instances of a key term 108 within a paragraph are indicated by varying convention, such as but not limited to the example “32a/b” to indicate a first and second instance of CKT 100 within paragraph 32.

As is further appreciated with respect to the link index 400, identified key terms may indeed be any instance of associated text and numerical elements. More specifically, and with respect to the example of a patent application, an identified key term may indeed be the reference to a figure, e.g., “FIG. 1.”

In at least one embodiment the index 118 incorporates appropriate command and control elements for a variety of global text selection processes such as for example the “find” and/or “find all” commands as are commonly utilized in word processing and illustrating applications.

Having so identified a key term 108, and linked each additional instance thereof among the plurality of documents, the method 200 permits the identification of additional key terms, decision 212. Indeed if the identification of additional key term is desired, the method 200 returns to block 204 for the identification of yet another key term. As illustrated, the method 200 is shown to return for the identification of the additional key term(s) within the first document 102. It is understood and appreciated that in varying embodiments, subsequent identification of one or more additional key terms may be made in any of the associated documents.

With respect to the depiction provided in FIG. 3 and the exemplary process of identifying a key term 108 as set forth above, it is also to be understood and appreciated that CKT 100 employing method 200 can be used to coordinate consistency of key terms throughout a plurality of documents after the documents have been created. Further, although the discussion above presents the use of a word processing document 306 and a illustration document 308, CKT 100 and method 200 are not limited to two documents. Indeed in at least one embodiment a second word processing document, not shown, providing a listing of key term 108 may be provided and used to seed the identifying and linking of key terms as between the initial word processing document 306 and the illustration document 308.

The advantageous value of CKT 100 and/or method 200 is not limited to application with pre-existing documents. Indeed a key term 108 may be identified to CKT 100 before additional instances of the key term have been created in either document. More specifically, CKT 100 employing method 200 can also be used to coordinate consistency of key terms 108 throughout a plurality of documents as one or both of the documents are being created.

In at least one embodiment, CKT 100 and/or method 200 is structured and arranged to provide suggestive autocomplete for key terms 108. More specifically, in response to a user entering a new or editing existing text so as to present at least a root portion of the text element 110, e.g., “CK,” of a key term 108, the most likely key term 108, e.g., “CKT 100” is spontaneously generated and suggested to the user for autocomplete.

If the user desires to accept the suggested autocomplete, he or she can advance the cursor twice to the right, or by some other means indicate a desire for acceptance. If on the other hand the autocomplete is incorrect or otherwise not desired, the user need only continue typing and the autocomplete suggestion will be removed.

Typically autocomplete operations are dependent upon the number of characters typed, and in some cases the context of other words associated with the characters being typed in a quasi heuristic process to predict the intended term. Indeed many methodologies exist for predictive autocomplete and may be adapted for use in CKT 100 and/or method 200.

Similar methodology to autocomplete process can also be adapted so as to track and automatically note new instances of previously identified key terms 108 as entered by a user. In varying embodiments the user can be given the option for a key stroke confirmation to validate each subsequent automatic identification of a key term, or to engage a validation process at a later time.

In addition, in at least one embodiment, CKT 100 and/or method 200 can be further structured and arranged to advantageously assist a user by presenting the next available number as a numerical element for a new key term 108. More specifically, when typing in a new element, such as “widget” the user may signal to CKT 100 the desire for assistance in numbering, such as by a series of key strokes—e.g., ctrl-shift-n. It is not uncommon for the numbering of elements to follow a convention, such as incrementing by two, the consistent use of even or odd values, and the use of the first digit to indicate the figure in which the element was first described, e.g., 100 series elements are first shown and described with respect to FIG. 1, 200 series elements are first shown and described with respect to FIG. 2, 300 series elements are first shown and described with respect to FIG. 3 and so on and so forth.

In addition to a series of key strokes for assistance with numbering, the same or alternative key strokes, e.g., ctrl-shift-k, may be employed for the user of CKT 100 to indicate a new key term has just been added. To assist with proper tracking and the coordination of consistency, in at least one embodiment a new key term will be highlighted or otherwise visually marked at least until the user applies the key term in the second document. As such, the user of CKT 100 is visually cued to the presence of a key term in only one document—either the word processing document or the illustration document. Such highlighting or visual marking can also be applied in the general key term indicating process described above.

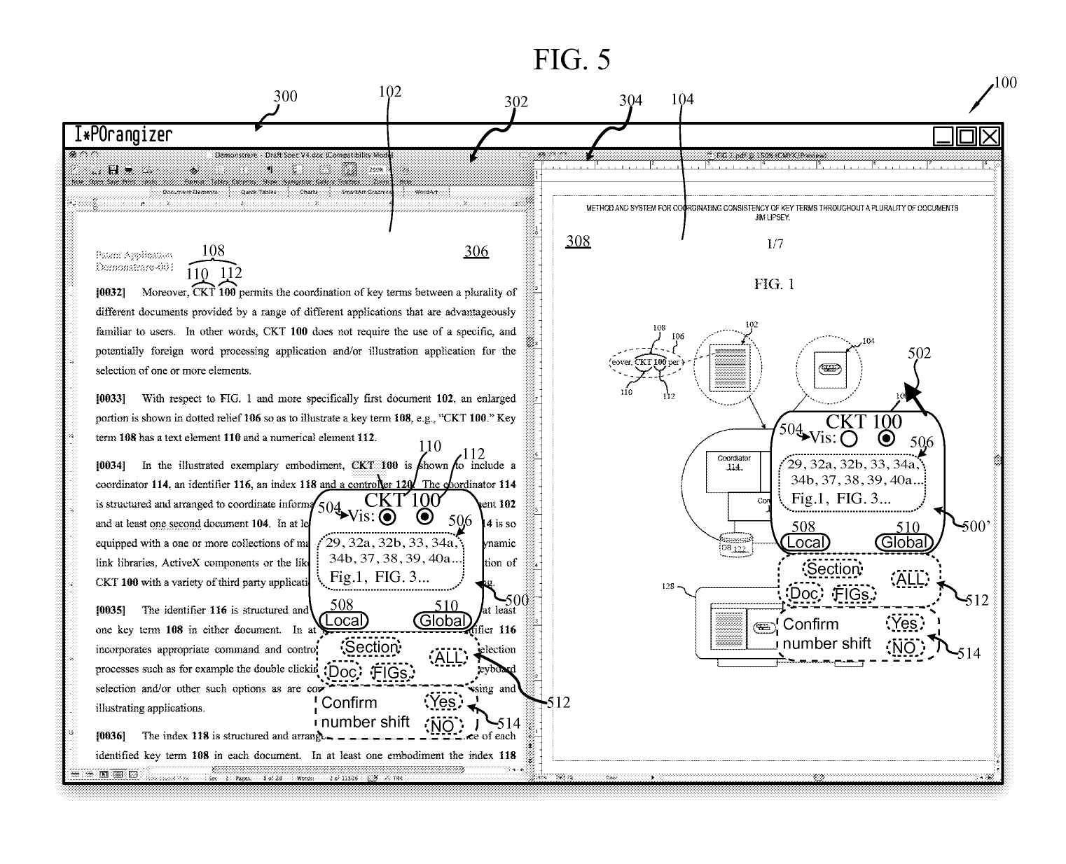

As the index 400 contains a listing of all numerical elements 112 associated with all identified key terms 108, CKT 100 and/or method 200 can reference the index to suggest the next available number. In varying embodiment, the incrementing for the numerical element can be user adjusted, e.g., increment by 1, 2 or 3, and set for even or odd values. Further still, in at least one embodiment CKT 100 and/or method 200 retains an indicator for the last numerical value used in the paragraph or section, and/or the last reference to a figure, e.g., “FIG. 2” —as such CKT 100 and/or method 200 not only can provide the next available numerical element for a new key term, but the additions made in a section of the description regarding FIG. 2 will have appropriate new number element suggestions for 200 series numbers and additions made in a section of the description regarding FIG. 5 will have appropriate new number element suggestions for 500 series numbers.

Returning to FIG. 2 and general operation of method 200, if the identification of additional key terms is not presently desired, the method 200 awaits the occurrence of an event, decision 214. As shown, in at least one embodiment, the method 200 is configured to await the onset of either of two events. In at least one embodiment of a system structure and arranged to implement method 200, such as CKT 100, it is the controller 120 that is structured and arranged to direct reaction with respect to the occurrence of an event.

In the first instance 216 the event is the selection by a user of at least a portion of an identified key term 108 in one document or the other. In the second instance 218 the event is noting a user modification to a key term 108, block 220. Yet another event, not shown, would be an indication by a user to review the index 400. Moreover, additional events are certainly contemplated by the teachings of this method 200 and CKT 100 as they may relate to the users desires for options and ability related to coordinating the consistency of key terms between a plurality of documents. For the ease of discussion and illustration, two primary events have been selected for illustration and discussion.

In the first instance 216, the method 200 proceeds to present at least a portion of the index 400, block 222, such as floating bubble 500 shown in FIG. 5. As shown in FIG. 5 a portion of the key term 108 in the word processing document 306 has been suggestively illustrated to suggest selection by the user, thus invoking the presentation of floating bubble 500. With respect to the illustration document 308, the placement of the cursor 502 upon the item number 100 is sufficient to invoke the presentation of floating bubble 500′.

Floating bubble 500 is structured and arranged to provide several advantages for coordinating term consistency. In at least one embodiment, floating bubble 500 presents the key term 108, visibility option 504, a link navigation area 506 and at least a set of action buttons, e.g., local button 508 and global button 510. The visibility option 504 permits selective control for the visibility of the text element 110 and the numerical element 112 of the key term 108.

The link navigation area 506 permits the focus of the CKT 100 to shift from the currently selected instance of a key term 108 to another instance of the key term 108 in any related document. In the example shown, the link navigation area 506 displays 29, 32a, 32b, 33, 34a, 34b, 37, 38, 39, 40a . . . FIG. 1, FIG. 2 . . . as optional links to other instances of the currently selected key term 108. As indicated above, in at least one embodiment each key term 108 is enabled as hypertext, the underlying hypertext code operating to receive from the link index 400 at least a partial listing of other instances of the key term 108, each presented as a link in navigational area 506.

The action buttons permit advantageous granularity in the control of CKT 100 with respect to how changes are propagated throughout the plurality of related documents. In varying embodiments, floating bubble 500 may also provide thumbnail images (not shown) of the associated figures in which the key term 108 is found.

With respect to the drawings, and for example FIG. 1 it is noted that in many instances only the numerical element 112 is desired. In other instances, such as the general illustration (e.g., visual depiction) of the components of CKT 100, the use of text elements 110 and numerical elements 112 is desired. In the drawings, when and where both the text element 110 and the numerical element 112 are desired to both be visible, in at least one embodiment, CKT 100 and/or method 200 provides that the elements are centered and stacked.

With respect to the issue of visibility control, in the word processing document 306 visibility in at least one embodiment is achieved by optionally displaying or not displaying an element, e.g., the text element 110 or the numerical element 112. The non-displayed element is maintained, such as in associated metadata so that it can be displayed, i.e., rendered visible, when and as desired.

In the drawings, in at least one embodiment the invisibility of either element can be achieved without removing the element from display. In other words, both the text element 110 and the numerical element 112 are in fact displayed, but one or the other may be rendered as non-visible by adjusting the color property or transparency of the text element 110 and the numerical element 112.

Moreover, in varying instances, such as for editing, discussion with inventors, preparation of foreign claim sets and foreign abstracts, or other moments and settings of desire, CKT 100 and/or method 200 advantageously permits granularity of control for the visibility of the both the text element 110 and the numerical element 112 of each key term 108.

In at least one embodiment the floating bubbles 500 and 500′ are shown to appear proximate to the key term 108 selected and superimposed upon the document from which the selection was made. In at least one alternative embodiment, the floating bubble 500, may in actuality be an additional window or bubble that is presented separately and that does not overlap or impose upon the document from which the selection was made.

For the floating bubble 500 shown with respect to the word processing document 306, the visibility of both the text element 110 and the numerical element 112 is selected. For the floating bubble 500′ shown with respect to the illustration document 308, the visibility of the text element 110 is indicated as off whereas the visibility of the numerical element 112 is indicated as on.

In addition, as suggested above the floating bubble 500 provides navigation links to other instances of the key term 108 in either document. As a key term 108 may occur more than once in a paragraph, in at least one embodiment a convention is adopted to identify each successive instance within a paragraph. For example, as shown there are two instances of “CKT 100” in paragraph 0032. The first such instance is therefore indicated as 32a and the second instance is 32b.

The method permits receiving a user selection, such as by clicking on a reference to a paragraph or Figure, from the portion of the index displayed, block 224. Moreover, clicking on a link reference will shift the focus to the instance selected, and if necessary the document selected, block 226. In other words, if the “FIG. 1” link is selected in floating bubble 500 the focus shifts to the illustration document and the selection of the key term as embedded and linked in FIG. 1.

Two additional features are shown with respect to the exemplary floating bubbles, 500 and 500′—a local button 508 and a global button 510. As indicated above, there is at least a second instance 218 of an event for which method 200 is responsive, the detection of a modification to a key term 108. In the event that a user modifies a key term, the user is presented with the option to make the change local, as in effective upon only the currently selected and edited key term 108, or global, decision 228.

With respect to the global change option, in at least one embodiment selection of the global button 510 provides an additional bubble 512 that presents additional options permitting the user to specify how global the update should be—for example as shown, the user may indicate a preference to make the update effective upon the current section, the current document, the figures or All, block 230. In addition, where an edit is effective upon the numerical element 112, an additional bubble 514 may be provided so as to permit the user to confirm an appropriate shift of the numerical elements, if necessary.

It is not uncommon for inadvertent errors to be introduced into one or more documents such that multiple key terms 108 though having different text elements 110 have the same numerical element 112. It is also not uncommon during the revision of a draft word processing document or illustration document for the user to desire to introduce one or more additional key elements that were not previously identified. In terms of patent applications, it is not uncommon for the numerical elements to follow a logical progression, e.g., the order of introduction. By presenting elements and their numerical identifiers in sequential order the reader of the document is aided in his or her quest to identify elements as he or she develops an understanding of the disclosed invention.

With respect to this present application, it would be potentially confusing for the key term of the numerical element 112 to be inadvertently identified as 114, the numerical element assigned to the controller 114. Likewise the introduction of a new element would be potentially disjointed if assigned a number significantly out of sequence for the point of insertion.

Embodiments of CKT 100 and method 200 advantageously permit the correction of erroneous duplication of numerical elements as between otherwise distinct key terms 108 and permits the insertion or deletion of additional key terms. The methodology for maintaining order and permitting shifting of the numerical elements can take many forms. For example, in at least one embodiment, each numerical element is assigned an additional unique reference number and additional information, e.g., metadata, so as to identify either or both the preceding numerical reference and the subsequent numerical reference.

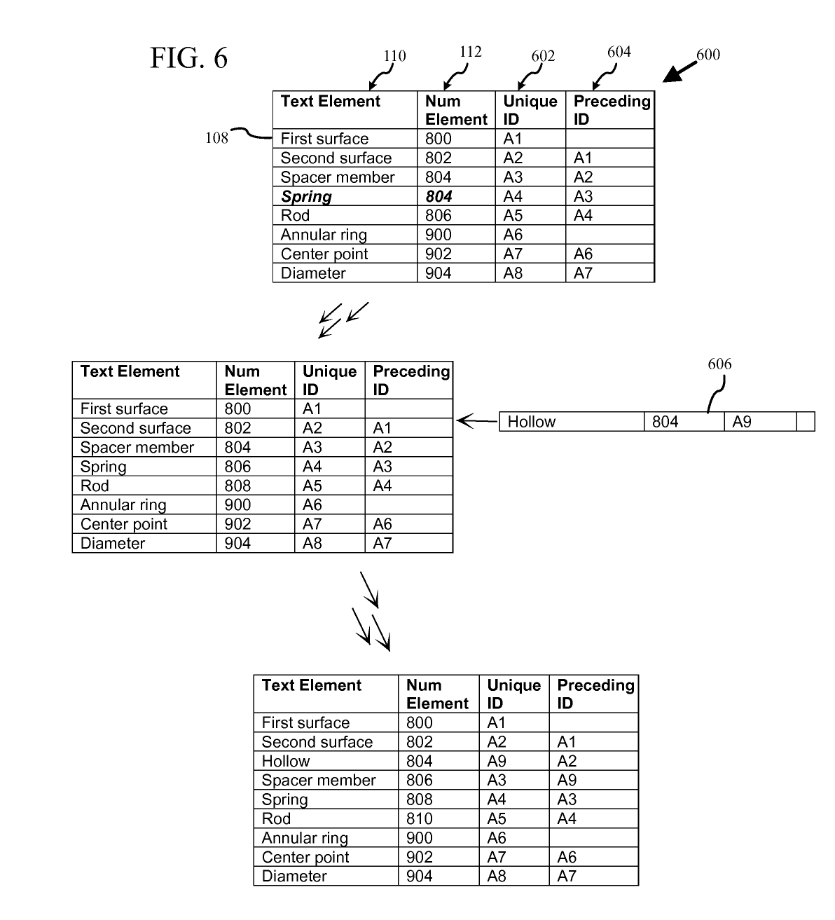

The addition of a new key value with a numerical element previously assigned, or the discovery of a key value with a duplicated numerical element is therefore not disabling. Those skilled in the art will appreciate that the unique reference number and information regarding precedent and subsequent numerical reference values permits the displayed numerical element 112 to be adjusted without loss of tracking control. An example for at least one embodiment is presented in FIG. 6.

FIG. 6. illustrates at least one such embodiment. Represented in a table 600, each key term 108 receives a unique identifier 602 and a reference to the previous key term 108 identifier, preceding identifier 604 if present. As shown in FIG. 6 for key term “first surface 800,” as the first element in the sequence there is no preceding identifier 604. Whereas other figures and illustrations regarding this document have used representative portions of this document, for this example an unrelated list of key terms 108 is provided with an arbitrary set of numerical elements, e.g., series 800 and 900 that are not otherwise used for the identification of CKT 100 elements.

With respect to this arbitrary list of key terms, “first surface 800” is assigned unique identifier A1 but has no reference to a preceding identifier 604. Similarly, “second surface 802” is assigned unique identifier A2 and has a reference to preceding identifier A1. As is apparent in the example table, there are two instances of the numerical element 804—first for a “spacer member” and then again for “spring”—the “spring 804” entry has been bolded and placed in italics for ease of identification. To simply adjust the numerical element of the “spring” to be 806 would create a conflict with “rod 806.” However, by utilizing the unique identifiers, the numerical element for “spring” can be shifted to 806 and “rod” can be shifted to “808.

The addition of a new key term 606 with a previously used numerical element is also easily accommodated. For example, the user of CKT 100 desires to enter a new key term 606, e.g., “hollow 804.” This new key term 606 receives a unique identifier 602 in this exemplary case shown to be “A9.” The table 600 is updated to reflect the placement of “hollow 804” as after “second surface 802” and before “spacer member 806.” By adjusting the references for the preceding identifiers 604 proper sequential order is maintained and the subsequent numerical elements 112 for each of the key terms in the 800 series sequence can be appropriately shifted.

In at least one embodiment, in addition to the preceding identifier 604, each entry of a key term 108 may also include a successive identifier (not shown). In varying embodiments, the unique identifiers 602 and preceding identifiers 604 are incorporated as part of the index 400, however they have been illustrated separately for ease of discussion and illustration.

That each key term 108 has a text element 110 and a numerical element 112, and that the numerical elements can be shifted is highly advantageous for CKT 100 and method 200. Without such advantageous manipulation, to revise a description so as to adjust all references to FIG. 1 to appear as references to FIG. 3 would be a complex and likely error prone manual task. Likewise to introduce an omitted element as 224 in a sequence running from 200 to 276 by increments of two would normally involve the shifting of some 38 numerical values, each of which might appear from 1 to N times in the description and accompanying figures—a daunting task. As CKT 100 and/or method 200 provide this adjustment as an automated process the accuracy, consistency, and of course time and cost savings over the traditional manual process is highly advantageous.

With respect to a patent application it should also be noted that a key term 108 is not simply relegated to a descriptive term in the written description or an element depicted in one or more drawings, or even the identification of a specific FIG. The ability of the key term 108 to display or hide the text element of the key term permits the key term identification process to be applied to page numbering, e.g., “1/12″” as is the expected convention for patent illustrations.

More specifically, each page can be given a key term “drawing 1/12″” with the term “drawing” being the text element and “1/12″” being the numerical element 112. As the text element can be visually repressed, the expected convention of page identification is maintained. If an identified FIG. # is amended or a new FIG. # is added such that the order of the presented figurers changes or the number of pages increases, CKT 100 and method 200 provide an advantageous ability to automatically adjust and re-identify the drawing pages according to expected convention.

In light of the example for page numbering convention, it is understood and appreciated that in at least one embodiment the numerical element 112 consists of one or more additional symbols, test and/or non-text characters. For example, a variation of CKT 100 may be identified as CKT 100A, CKT 100″ or in the case of a figure FIG. 1A, FIG. 1A′ or even as in the case of page numbering 1/12. Indeed, when CKT 100 is structured and arranged to advantageously suggest next in sequence numerical elements, it is understood and appreciated that the suggestion will include the appropriate non-numerical element, e.g., A, a, ii, #/12, or the like.

Returning to FIGS. 2 and 5, it is understood and appreciated that a user can escape from the options of floating bubble 500 by simply clicking a mouse cursor elsewhere, hitting an escape key. Whether the user has directed movement to a selected instance of a key term 108 as in block 226, indicated a local or global change preference as in decision 228, or simply escaped from floating bubble 500 by other action or inaction, the method 200 persists until closed or terminated by the user, decision 232.

With respect to the above description of the first instance 216 and the second instance 218 of responding to a user event, it is to be understood and appreciated that the instances may be combined. For example a user may select a key term 108, select a link from the navigation area 506 to move to another instance of the key term 108, edit that instance, and then confirm that change to be either a local edit or a global edit.

The adventurous ability for coordinating consistency of terms in a plurality of documents is indeed most beneficial. However it is also likely that either or both of the first document 102 and the second document 104, e.g., the word processing document 306 and the illustration document 308 will be shared with other users. In some cases these users may have access to the same CKT 100 system environment or their own CKT 100 system. In other instances they may not be utilizing CKT 100 or any embodiment of method 200.

To provide the greatest opportunity for long term consistency and overall editing harmony, the index 400 and associated metadata for links throughout the documents can be stored as metadata within the word processing document or the illustration document. If a CKT 100 equipped system is provided with a document so encoded it can and will make use of such index and associated metadata links to facilitate advantageously enhanced editing.

If a user opens the metadata embedded file on a system not otherwise adapted as a CKT 100 system, the metadata will remain unchanged. As the metadata can contain a date code, when the document is later returned to a CKT 100 equipped system, CKT 100 can and will compare the date code in the metadata with the date code on the file and can be immediately aware of possible edits that were not otherwise overseen by CKT 100 or an embodiment of method 200.

In yet another embodiment, the index 400 and associated metadata is warehoused in a dedicated database, such as for example optional database 122 shown in FIG. 1. The index 400 and associated metadata for the linking of references is maintained and identified by unique identifiers embedded to both the first document 102 and the second document 104. Moreover, in such an embodiment, CKT 100 receives the unique identifier and then retrieves from database 122 the appropriate index 400.

Embedded date code may again be utilized to identify edits that may have occurred outside of the CKT 100 environment. The use of a dedicated database 122 can advantageously permit multiple parties to work on a plurality of related documents simultaneously. As updates, additions or deletions can be treated as atomic transactions, two parties can not revise a key term simultaneously and all revisions will be immediately evident to all parties.

Moreover, CKT 100 and method 200 may be provided as a network or web-based environment, or in standalone installations. Indeed, a patent attorney or patent agent can prepare an enhanced application utilizing an embodiment of CKT 100 and make the application available to a patent examiner, who if also equipped with an embodiment of CKT 100 can enjoy the advantageous ability to navigate between instances of key terms and thereby more fully and easily understand not only the narrative description but also appreciate supporting enablement of one or more key terms 108 as presented in the claims.

More specifically, it is to be understood and appreciated that any reader of the first and second documents 102 and 104 can be assisted in his or her understanding of the documents, regardless of the desire to edit, or even ability to edit, by the use of CKT 100 and or method 200. The reader can at any time and for any key term 108 immediately receive a clear map of all instances of the selected key term 108. Such immediate identification is of course likely to be a time saver, but also may aid in improved understanding for the opportunity for inadvertent distraction to set in, or a feeling of stopping and starting when hunting for key terms 108 is significantly minimized.

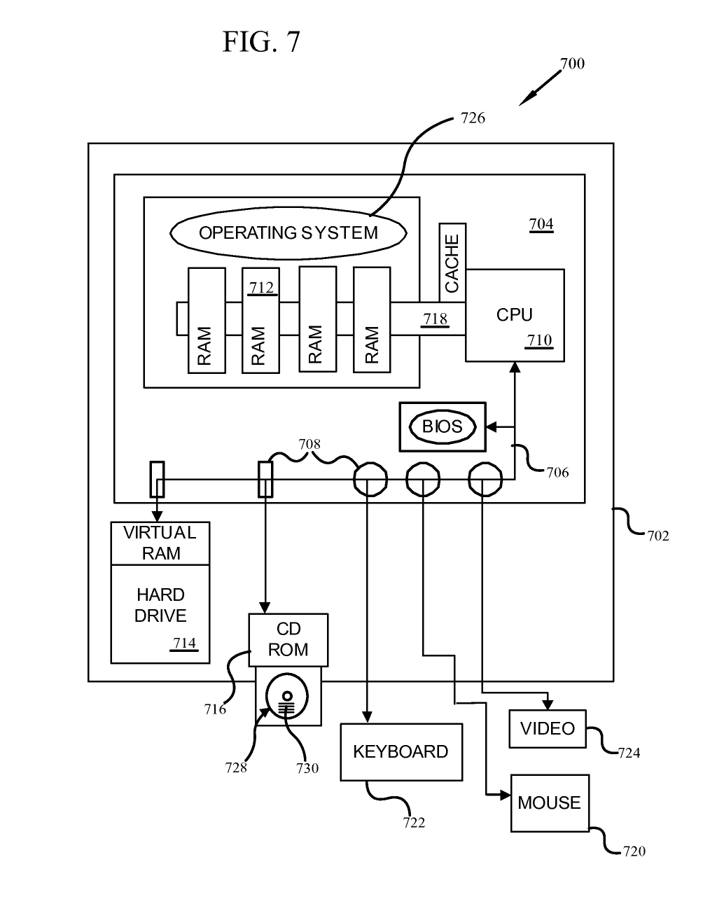

With respect to the above description of CKT 100 and method 200, it is understood and appreciated that the method may be rendered in a variety of different forms of code and instruction as may be preferred for different computer systems and environments. To expand upon the initial suggestion of a computer implementation suggested above, FIG. 7 is a high level block diagram of an exemplary computer system 700. Computer system 700 has a case 702, enclosing a main board 704. The main board has a system bus 706, connection ports 708, a processing unit, such as Central Processing Unit (CPU) 710 and a memory storage device, such as main memory 712, hard drive 714 and CD/DVD ROM drive 716.

Memory bus 718 couples main memory 712 to CPU 710. A system bus 706 couples hard drive 714, CD/DVD ROM drive 716 and connection ports 708 to CPU 710. Multiple input devices may be provided, such as for example a mouse 720 and keyboard 722. Multiple output devices may also be provided, such as for example a video monitor 724 and a printer (not shown).

Computer system 700 may be a commercially available system, such as a desktop workstation unit provided by IBM, Dell Computers, Gateway, Apple, Sun Micro Systems, or other computer system provider. Computer system 700 may also be a networked computer system, wherein memory storage components such as hard drive 714, additional CPUs 710 and output devices such as printers are provided by physically separate computer systems commonly connected together in the network. Those skilled in the art will understand and appreciate that physical composition of components and component interconnections comprising computer system 700, and select a computer system 700 suitable for the schedules to be established and maintained.

When computer system 700 is activated, preferably an operating system 726 will load into main memory 712 as part of the boot strap startup sequence and ready the computer system 700 for operation. At the simplest level, and in the most general sense, the tasks of an operating system fall into specific categories—process management, device management (including application and user interface management) and memory management.

In such a computer system 700, the CPU 710 is operable to perform one or more of the methods of representative symbol generation described above. Those skilled in the art will understand that a computer-readable medium 728 on which is a computer program 730 for generating representation symbols may be provided to the computer system 700. The form of the computer-readable medium 728 and language of the program 730 are understood to be appropriate for computer system 700. Utilizing the memory stores, such as for example one or more hard drives 714 and main memory 712, the operable CPU 710 will read the instructions provided by the computer program 730 and operate to perform as CKT 100 as described above.

Changes may be made in the above methods, systems and structures without departing from the scope hereof. It should thus be noted that the matter contained in the above description and/or shown in the accompanying drawings should be interpreted as illustrative and not in a limiting sense. The following claims are intended to cover all generic and specific features described herein, as well as all statements of the scope of the present method, system and structure, which, as a matter of language, might be said to fall therebetween.

What is claimed is:

1. A method of coordinating consistency of key terms throughout a plurality of documents, the method comprising:
identifying at least one key term in a first document provided by a first third-party application, the key term having at least a text element and a numerical element;
linking each additional instance of the key term in the first document;
linking each instance of the key term in at least one second document provided by a second third-party application;
establishing for each identified key term a link index for all instances of each key term in each document, the index permitting navigation to any specific instance of the key term in the first or second document; and
permitting for each instance of each key term the visibility of the elements to be selectable from the group consisting of; both the text element and the numerical element are visible, the text element is visible and the numerical element is invisible, and the text element is invisible and the numerical element is visible.

2. The method of claim 1, further including responding to a user event by:
in a first instance;
presenting at least a portion of the index to a user n response to a user event; and
receiving a user selection from the index and moving to the linked selected instance in either the first or second document;
and in a second instance;
noting a user modification to either the text element or the numerical element of a key term;
and querying the user to confirm the modification to at least a subset of the linked instances of the key term.

3. The method of claim 1, wherein the first third-party application is a word processor and the second third-party application is a drawing application.

4. The method of claim 1, further including providing an environment for interrelating data as between the first document and the second document.

5. The method of claim 4, wherein the environment is provided as a plugin for either the first third-party application or the second-third-party application.

6. The method of claim 1, wherein the numerical element further includes one or more additional symbol, text and non-text characters.

7. The method of claim 1, wherein the method is stored on a non-transitory computer-readable medium as a computer program which, when executed by a computer, will perform the steps of coordinating consistency of key terms throughout a plurality of documents.

8. A system for performing the method of claim 1, the system comprising:
a coordinator structured and arranged to coordinate information between at least one first word processing document and at least one second illustration document;
an identifier, structured and arranged to permit identification of at least one key term in either document, the key term having at least a text element and a numerical element, the identifier further permitting visibility determination of text element and the numerical element; and
an index structured and arranged to link and index each instance of each identified key term in each document.

9. A system of coordinating consistency of key terms throughout a plurality of documents, comprising:
a coordinator structured and arranged to coordinate information between at least one first word processing document and at least one second illustration document;
an identifier, structured and arranged to permit identification of at least one key term in either document, the key term having at least a text element and a numerical element;
an index structured and arranged to link and index each instance of each identified key term in each document;
a controller structured and arranged to control a users interactions with either document, the controller responding to a user event by;
in a first instance;
presenting at least a portion of the index to a user in response to a user event; and
receiving a user selection from the index and moving to the linked selected instance in either the first or second document;
and in a second instance;
noting a user modification to either the text element or the numerical element of a key term;
and querying the user to confirm the modification to at least a subset of the linked instances of the key term.

10. The system of claim 9, wherein the first word processing document is provided by a third-party word processor and the second illustration document is provided by a third-party drawing application.

11. The system of claim 10, wherein the third-party word processor is selected from the group consisting of Word, WordPerfect, Pages . . . .

12. The system of claim 10, wherein the third-party drawing application is selected from the group consisting of Adobe Illustrator, Microsoft PowerPoint, Microsoft Visio, Keynote . . . .

13. The system of claim 9, wherein the system is a plugin for a third-party word processor.

14. The system of claim 13, wherein the plugin is structured and arranged to invoke a drawing application to provide the second illustration document.

15. A method of coordinating consistency of key terms throughout a plurality of documents, the method comprising:
providing an environment for interrelating data as between at least one word processing document and at least one illustration document;
identifying at least one key term in either the word processing document or the illustration document as a first document, the key term having at least a text element and a numerical element;
linking each additional instance of the key term in the first document;
linking each instance of the key term in at least one second document; and
establishing for each identified key term a link index for all instances of each key term in each document, the index permitting navigation to any specific instance of the key term in the first or second document.

16. The method of claim 15, further including responding to a user event by:
in a first instance;
presenting at least a portion of the index to a user in response to a user event; and
receiving a user selection from the index and moving to the linked selected instance in either the first or second document;
and in a second instance;
noting a user modification to either the text element or the numerical element of a key term;
and querying the user to confirm the modification to at least a subset of the linked instances of the key term.

17. The method of claim 15, wherein the word processing document is provided by a third-party word processor and the illustration document is provided by a third-party drawing application.

18. The method of claim 17, wherein the environment is established by a plugin for the third-party word processor.

19. The method of claim 18, wherein the plugin is structured and arranged to invoke the third-party drawing application to provide the at least one illustration document.

20. The method of claim 17, wherein the third-party word processor is selected from the group consisting of Word, WordPerfect, Pages . . . .

21. The method of claim 17, wherein the third-party drawing application is selected from the group consisting of Adobe Illustrator, Microsoft PowerPoint, Microsoft Visio, Keynote . . . .

22. The method of claim 15, wherein the environment is provided by an application structured and arranged to interact with a third-party word processor and a third-party drawing application.

23. The method of claim 15, wherein the numerical element further includes one or more additional symbol, text and non-text characters.

24. The method of claim 15, wherein for each instance of each key term, the visibility of the elements is selected from the group consisting of; both the text element and the numerical element are visible, the text element is visible and the numerical element is invisible, and the text element is invisible and the numerical element is visible.

25. The method of claim 24, wherein within the illustration document, when the text element and the numerical element are both visible, the elements are centered and stacked.

26. The method of claim 15, further including a second word processing document providing a listing of key terms, the list of key terms seeding the identifying and linking of the key terms as between the word processing document and the illustration document.

27. The method of claim 26, further including visually identifying each instance of a partial key term match in each document.

28. A method of coordinating consistency of key terms throughout a plurality of documents, the method comprising:
providing an environment for interrelating data as between at least one word processing document provided by a third-party word processor and at least one illustration document provided by a third-party drawing application;
identifying at least one key term in either the word processing document or the illustration document as a first document, the key term having at least a text element and a numerical element;
linking each additional instance of the key term in the first document;
linking each instance of the key term in at least one second document;
permitting for each instance of each key term the visibility of the elements to be selectable from the group consisting of; both the text element and the numerical element are visible, the text element is visible and the numerical element is invisible, and the text element is invisible and the numerical element is visible;
establishing for each identified key term a link index for all instances of each key term in each document, the index permitting navigation to any specific instance of the key term in the first or second document; and
responding to a user event by;
in a first instance;
presenting at least a portion of the index to a user in response to a user event; and
receiving a user selection from the index and moving to the linked selected instance in either the first or second document;
and in a second instance;
noting a user modification to either the text element or the numerical element of a key term;
and querying the user to confirm the modification to at least a subset of the linked instances of the key term.

29. The method of claim 28, wherein the environment is established by a plugin for the third-party word processor.

30. The method of claim 29, wherein the plugin is structured and arranged to invoke the third-party drawing application to provide the at least one illustration document.

31. The method of claim 28, wherein the environment is provided by an application structured and arranged to interact with the third-party word processor and the third-party drawing application.

32. The method of claim 28, wherein the numerical element further includes one or more additional symbol, text and non-text characters.

33. The method of claim 28, wherein within the illustration document, when the text element and the numerical element are both visible, the elements are centered and stacked.

34. The method of claim 28, further including a second word processing document providing a listing of key terms, the list of key terms seeding the identifying and linking of the key terms as between the word processing document and the illustration document.

35. The method of claim 28, further including visually identifying each instance of a partial key term match in each document.

36. The method of claim 28, wherein the numerical elements are sequential, and when adding a new key term in either the first word processing document or the illustration document, automatically providing the next unused sequential numerical element.

37. The method of claim 28, wherein entering a root portion of a key term in the word processing document triggers an autocomplete option displaying a list of one or more complete key terms containing the root portion.
